(19) United States
(12) Patent Application Publication
(10) Pub. No.: US 2025/0296043 A1
(43) Pub. Date: Sep. 25, 2025

(54) GREENHOUSE GAS ABATEMENT

(71) Applicant: Chevron U.S.A. Inc., San Ramon, CA (US)

(72) Inventors: Ramesh Anant Kini, Katy, TX (US); Nirav Narendra Shah, Sugar Land, TX (US)

(21) Appl. No.: 18/821,753

(22) Filed: Aug. 30, 2024

Related U.S. Application Data
(60) Provisional application No. 63/568,250, filed on Mar. 21, 2024.

(51) Int. Cl. B01D 53/78; B01D 53/14; B01D 53/52; B01D 53/54; B01D 53/62; B01D 53/72

(52) U.S. Cl. CPC B01D 53/78; B01D 53/1468; B01D 53/1475; B01D 53/1487; B01D 53/1493; B01D 53/52; B01D 53/54; B01D 53/62; B01D 53/72; B01D 2252/103; B01D 2252/602; B01D 2257/102; B01D 2257/304; B01D 2257/504; B01D 2257/7025; B01D 2258/0283

(57) ABSTRACT

The present application relates generally to processes, systems, and compositions for greenhouse gas abatement. Typically, a greenhouse gas comprising methane, carbon dioxide, or a mixture thereof is reacted with water under conditions to form a mixture comprising hydrates. The formed mixture comprising hydrates is transported to a location in need of gas. The transporting is conducted under conditions sufficient to preserve at least a portion of the hydrates in the formed mixture. The transported mixture comprising preserved hydrates is then converted to gas at or near the location in need of gas.

### CROSS REFERENCE TO RELATED APPLICATION

This application is a non-provisional application claiming the benefit of and priority to U.S. Provisional Patent Application No. 63/568,250, filed on Mar. 21, 2024, entitled “GREENHOUSE GAS ABATEMENT.”

### FIELD OF THE INVENTION

The present invention relates generally to processes, systems, and compositions for greenhouse gas abatement using hydrates.

### BACKGROUND AND SUMMARY

A number of companies are looking for ways to reduce flare gas emissions to meet lower carbon goals. Flare gas emissions typically contribute to the total greenhouse gas emission. In some industries, excess gas may be flared to relieve pressure in, for example, upset conditions or when sending gas to sales is not possible.

In one embodiment, the application pertains to a process wherein a greenhouse gas comprising methane, carbon dioxide, or a mixture thereof is reacted with water under conditions to form a mixture comprising hydrates. The formed mixture comprising hydrates is transported to a location in need of gas. The transporting is conducted under conditions sufficient to preserve at least a portion of the hydrates, for example, at least about 20%, or at least about 30%, or at least about 40% of the hydrates in the formed mixture. The transported mixture comprising preserved hydrates is then converted to gas at or near the location in need of gas.

In another embodiment the application pertains to compositions comprising hydrates formed from a greenhouse gas; and one or more of a catalyst, a promoter, a hydrate preservative, or any combination thereof.

In another embodiment the application pertains to systems comprising a gas-to-hydrate reactor; and a transportable storage module for storing hydrates formed in the gas-to-hydrate reactor.

### BRIEF DESCRIPTION OF THE DRAWINGS

So that the manner in which the above recited features, advantages, and objects of the present invention are attained and can be understood in detail, a more particular description of the invention, briefly summarized above, may be had by reference to the embodiments thereof which are illustrated in the appended drawings. It is to be noted, however, that the appended drawings only illustrate preferred embodiments of this invention and are therefore not to be considered limiting of its scope, for the invention may admit to other equally effective embodiments that vary only in detail. In the drawings:

FIG. 1 illustrates a schematic of a flare gas-to-hydrates process.

FIG. 2 illustrates a rate of flare gas conversion to hydrates in a reactor, pure C1 hydrate formation rate, and pure CO₂ hydrate formation rate.

FIG. 3 illustrates gas conversion rate vs. mixing speed.

FIG. 4 illustrates hydrate dissociation over time.

FIG. 5 illustrates a process flow diagram for a representative flare gas-to-hydrates process using a representative system.

### DETAILED DESCRIPTION

Certain terms are used throughout the following description and claims to refer to particular system components. As one skilled in the art will appreciate, different companies may refer to a component by different names.

### Definitions

The terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s) but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

Unless defined otherwise, all technical and scientific terms used herein have the same meanings as commonly understood by one of skill in the art to which the disclosed invention belongs. All citations referred herein are expressly incorporated by reference.

### General Process

In one embodiment the application pertains to processes for greenhouse gas abatement. Typically, a greenhouse gas comprising methane, carbon dioxide, or a mixture thereof is reacted with water under conditions to form a mixture comprising hydrates. The formed mixture comprising hydrates is transported to a location in need of gas. The transporting is conducted under conditions sufficient to preserve at least about 20%, or at least about 30%, or at least about at least about 40% of the hydrates in the formed mixture. The transported mixture comprising preserved hydrates is then converted to gas at or near the location in need of gas.

### Reacting

The reacting step generally comprises reacting a greenhouse gas comprising methane, carbon dioxide, or a mixture thereof with water under conditions to form a mixture comprising hydrates. The source of greenhouse gas is not particularly limited and may include, for example, any gas with one or more compounds that may be reacted with water to form one or more hydrates in a mixture or otherwise. By “hydrates” it is meant different types of hydrates, i.e., having a different chemical or physical composition by different number of a given element, different structure, different arrangement of molecules, and/or a different relative ratio of the various elements in a given hydrate formula. Representative greenhouse gas sources may include, for example, flare gas or any other emission in need of reducing greenhouse gas emissions. Other applications may include, without limitation, vent reduction, process equipment exhaust reduction, and/or fugitive emission reduction.

As described above, the greenhouse gas may comprise a flare gas or other emission that comprises carbon dioxide. Other components of the flare gas or emission may comprise, for example, various amounts of hydrogen sulfide, carbon dioxide, methane, ethane, propane, butanes, pentanes, hexanes, nitrogen, and other gases, or any mixture thereof. Some isomers of hexane can form hydrates. For example, methylcyclohexanes can form a structure H of hydrates which may be a different structure than one that is formed from smaller hydrocarbons.

The composition of various components of the greenhouse gas mixture is not particularly critical and the gas may have any suitable origin. In some cases, the greenhouse gas may be captured from flare gas emissions while in other cases it may be captured from, for example, a sea floor which gas may already comprise hydrates prior to reacting.

The mixture may typically comprise carbon dioxide and/or methane along with potentially other gases. For example, the mixture may also comprise hydrogen sulfide, ethane, propane, other alkanes or alkenes, nitrogen, or any mixtures thereof. In some embodiments it may be advantageous if the mixture comprises higher amounts of hydrogen sulfide and/or carbon dioxide which may contribute to higher amounts of hydrates being formed in the reaction with water.

In some embodiments, hydrogen sulfide may comprise at least about 2%, or at least about 2.5%, or at least about 3% or more, by mole of the greenhouse gas, for example, flare gas based on the total molar amount of greenhouse gas such as flare gas. In some embodiments, the greenhouse gas such as flare gas may comprise at least about 5% carbon dioxide, or at least about 5.5%, or even at least about 6% carbon dioxide or more by mole of the greenhouse gas, for example, flare gas based on the total molar amount of greenhouse gas. In some embodiments, methane is present in the greenhouse gas such as flare gas. In those cases, the gas may comprise at least about 50%, or at least 55%, or even at least 60% or more methane by mole of the flare gas based on the total molar amount of flare gas.

The water employed may be from any convenient source (e.g., produced or fresh water or seawater) so long as it adequately reacts with the greenhouse gas source to form hydrates. In some embodiments at least a portion of the water employed may comprise produced water from an oil or gas operation. Of course, if a field is not producing water, then other water sources may be employed if and until the field produces water. Depending upon the level and number of impurities in the produced water, it may be useful to first treat the produced water before reacting it with the greenhouse gas such as flare gas. Such treatment may vary depending upon the nature of the impurities but it may be useful to, for example, reduce salts or other impurities in the produced water.

The reacting may be conducted any suitable conditions to obtain the desired mixture of hydrate product or products. Such conditions may change depending upon, for example, the starting ingredients, equipment employed, and/or desired products. The reacting may be conducted at a temperature of less than about 10° C., or less than about 5° C., or even lower. If desired, a catalyst or promoter, e.g., a surfactant, may be employed that increases the rate of reaction and/or facilitates more favorable reaction conditions such as, for example, a lower reaction temperature or pressure.

The specific reaction conditions will, of course, vary depending upon, for example, the reactants, desired products, and equipment employed. In some embodiments, the reacting employs a mixing step to facilitate the reaction. Such mixing may be accomplished in any convenient manner. In some embodiments, the reacting conditions may comprise mixing via stirring wherein a mixing speed is at least about 200 rpm, or at least about 400 rpm, or at least about 600 rpm or higher. In some embodiments, conversion of the greenhouse gas such as a flare gas to hydrates during the reacting is greater than a rate of conversion of pure methane to hydrates at the same reaction conditions. “Flare gas” as used herein includes the burning of natural gas alone or along with other gaseous components during the production of hydrocarbons.

If desired, additives may be employed in the reacting step, the transporting step, the converting step or any combination thereof. Useful additives may include, for example, a catalyst, a promoter, a hydrate preservative to prevent or slow hydrate dissociation, or some combination thereof. Depending upon the nature and function of the additive or additives, they may be added to the water, the gas, the formed hydrates, or some combination thereof.

### Transporting

The formed mixture comprising hydrates may be transported to a location in need of gas. The specific transportation method is not particularly critical so long as the formed hydrates do not significantly dissociate. In some embodiments, the transporting is conducted under conditions sufficient to preserve at least about 20%, or at least about 30%, or at least about 40%, or at least about 50% or more of the hydrates in the formed mixture based on the total amount of hydrates formed in the reacting. The transporting may be by any convenient method including, truck, rail, pipeline, or other mechanism.

The specific conditions during transporting may vary depending upon the type of transport, the amount of formed hydrates, the desired amount of hydrates, and other factors. In some embodiments, the transporting may be conducted at a temperature of −10° C. or higher, or −5° C. or higher, or below about 5° C., or below about 0° C. The pressure may also vary during transporting and may depend to some extent upon the temperature employed during transport or vice versa. In some embodiments the transporting may be conducted at a pressure of less than about 110 psig or lower, or less than about 100 psig or lower, or less than about 90 psig or lower. On the other hand, the pressure during transporting may be above about 80 psig, or above about 85 psig or higher.

### Converting

Once the mixture comprising preserved hydrates has been transported to the desired location, it may be converted to gas by any suitable technique. Suitable techniques include, for example, lowering pressure and/or increasing temperature to a pressure and temperature at which the hydrates will convert to gas. The specific temperature and pressure may vary depending upon for example, the concentration of gas that formed the hydrates and/or the presence or absence of any additives or other components.

### Compositions and Systems

In other embodiments, the present application pertains to novel compositions of slurries (including, e.g., water, hydrates, and/or other components) or hydrate mixture compositions and systems comprising the same. Such compositions may comprise hydrates formed from a greenhouse gas; and one or more of a catalyst, a promoter, a hydrate preservative, or any combination thereof. In some embodiments the compositions may be sufficiently stable such that the composition is transportable at the temperatures and pressures described above, e.g., at a temperature of −5° C. or higher and a pressure of 100 psig or lower. In some embodiments the transported composition comprises at least about 20%, or at least about 30%, or at least about 40% or more of the hydrates remaining in the composition that were present prior to transport.

Suitable systems (portable or otherwise) are also contemplated herein. Such systems may comprise a gas-to-hydrate reactor and a transportable storage module for storing hydrates formed in the gas-to-hydrate reactor. In some embodiments the system may also have a module for dissociating hydrates formed in the gas-to-hydrate reactor.

### Examples

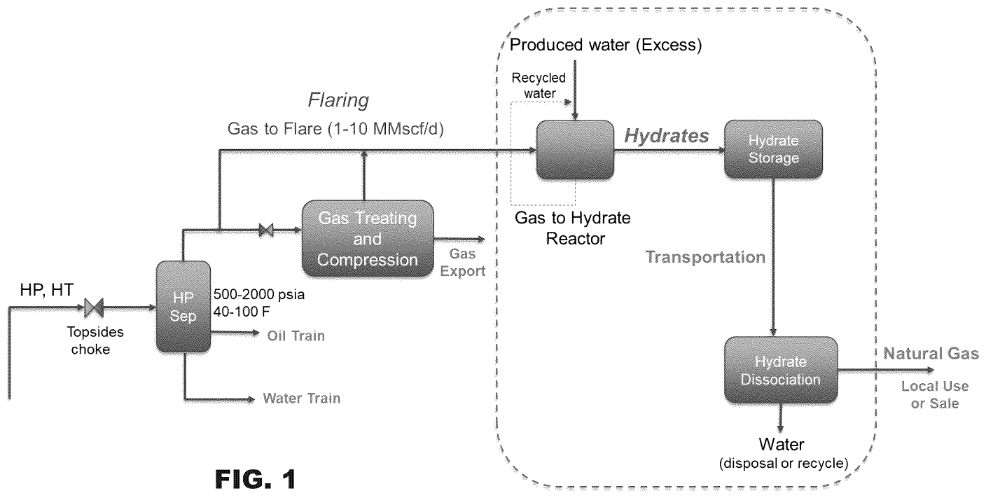

As shown in FIG. 1 an exemplary process includes: Step 1) Conversion of high-pressure flare gas-to-hydrates in a reactor, by mixing gas with cold water; Step 2) Preservation of hydrates formed; Step 3) Transportation of hydrates to a safer location; and Step 4) Conversion of hydrates to gas at ambient conditions for re-use.

A composition of flare gas comprising the following gas composition was employed in this example.

Gas Composition (mol %)

| | |
|---|---|
| Methane | 78.77 |
| Ethane | 6.28 |
| Propane | 1.86 |
| Isobutane | 0.08 |
| n-Butane | 0.28 |
| Isopentane | 0.05 |
| n-Pentane | 0.07 |
| Nitrogen | 1.62 |
| Carbon Dioxide | 8.16 |
| Hydrogen Sulfide | 2.82 |

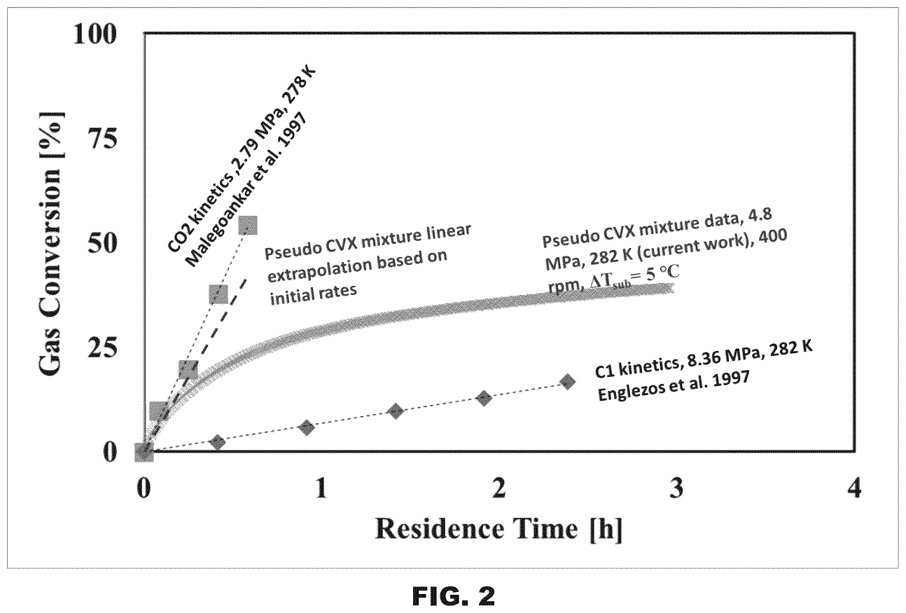

Step 1) Conversion of flare gas-to-hydrates. The above gas mixture was mixed with water in a stirred tank reactor at a temperature with supercooling of 5° C. to form hydrates. The rate of gas consumption was measured from the time the gas and water were mixed. The rate of gas conversion was less than the rate of pure CO₂ conversion to hydrates and more than pure methane conversion as shown in FIG. 2.

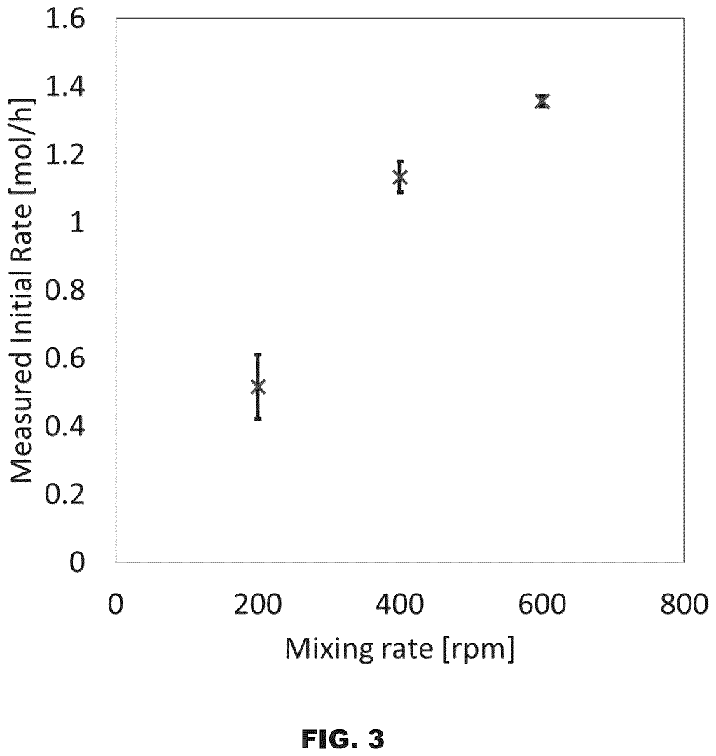

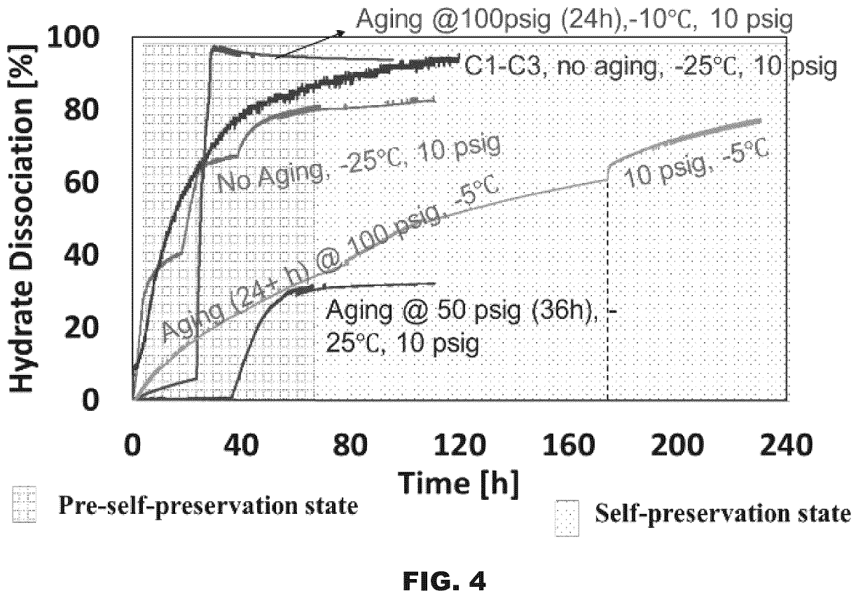

The rate of gas conversion was measured as a function of speed of impeller (stirring) in the reactor. The results suggest that a rate reaches a plateau with the mixing speed (as shown in FIG. 3).
Step 2) Preservation of formed hydrates. Procedures were employed to determine the stability of hydrates formed from the gas employed as shown in FIG. 4. In this example, the hydrates dissociated to around 60% of the original amount in 150 hours at −5° C. and 100 psig. The dissociation rate may be further optimized while keeping the hydrate storage P and T conditions closer to ambient conditions if preservation costs are a concern. For example, as one increases the temperature (or decreases the pressure) to ambient, the dissociation rate typically increases (e.g., hydrate melting is faster).

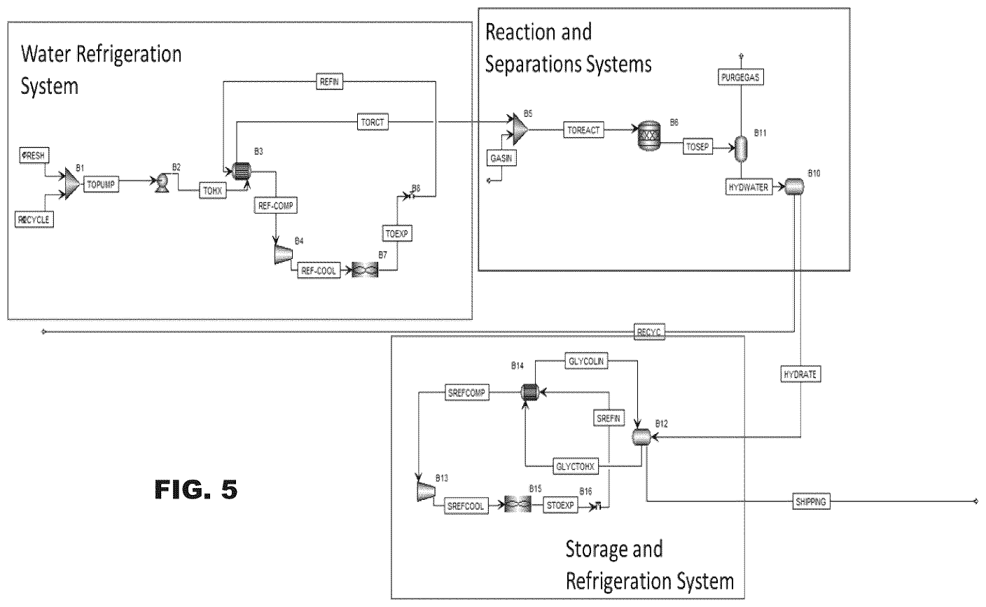

A representative process flow diagram is shown in FIG. 5. As shown in FIG. 5 a typical system may comprise a hydrate formation reactor, a refrigeration system, hydrate storage, and/or transportation to an end-use location. As shown and described herein, the systems, processes, and compositions may be useful in, for example, one or more of the following applications-flare gas reduction (routine and non-routine), process emission reduction, vent reduction, process equipment exhaust reduction, and/or fugitive emission reduction.

### Embodiments

1. A process for greenhouse gas abatement comprising:
reacting a greenhouse gas comprising methane, carbon dioxide, or a mixture thereof with water under conditions to form a mixture comprising hydrates;
transporting the formed mixture comprising hydrates to a location in need of gas wherein the transporting is conducted under conditions sufficient to preserve at least a portion of the hydrates in the formed mixture based on the total amount of hydrates formed in the reacting; and
converting the transported mixture comprising preserved hydrates to gas at or near the location in need of gas.
2. The process of embodiment 1 wherein the greenhouse gas is a flare gas.
3. The process of embodiment 2 wherein the flare gas further comprises hydrogen sulfide.
4. The process of embodiment 2 wherein the flare gas comprises at least about 5% carbon dioxide by mole of the flare gas based on the total molar amount of flare gas.
5. The process of embodiment 2 wherein the flare gas comprises at least about 50% methane by mole of the flare gas based on the total molar amount of flare gas.
6. The process of embodiment 2 wherein the flare gas comprises a mixture of methane and carbon dioxide and wherein the flare gas further comprises ethane, propane, butanes, pentanes, hexanes, nitrogen, or any mixture thereof.
7. The process of embodiment 1 wherein the reacting is conducted at a temperature of less than about 5° C.
8. The process of embodiment 2 wherein a rate of conversion of the flare gas-to-hydrates during the reacting is greater than a rate of conversion of pure methane to hydrates at the same reaction conditions.
9. The process of embodiment 1 wherein the transporting is conducted at a temperature of −5° C. or higher and a pressure of 100 psig or lower.
10. The process of embodiment 1 wherein the greenhouse gas is captured from a sea floor and wherein the greenhouse gas further comprises hydrates prior to reacting.
11. The process of embodiment 1 which further comprises adding a promoter to the greenhouse gas prior to reacting, during reacting, or both.
12. The process of embodiment 11 wherein the promoter comprises a surfactant.
13. The process of embodiment 1 wherein the reacting conditions comprise mixing and wherein a mixing speed is at least about 200 rpm.
14. The process of embodiment 1 wherein the reacting conditions comprise mixing and wherein a mixing speed is at least about 400 rpm.
15. The process of embodiment 1 wherein the reacting conditions comprise mixing and wherein a mixing speed is at least about 600 rpm.
16. The process of embodiment 1 which further comprises adding a hydrate preservative.
17. The process of embodiment 16 wherein the hydrate preservative prevents or slows hydrate dissociation.
18. The process of embodiment 1 which further comprises adding a catalyst to the reacting step.
19. The process of embodiment 1 wherein at least a portion of the water comprises produced water from an oil or gas operation.
20. A composition comprising:
hydrates formed from a greenhouse gas; and
one or more of a catalyst, a promoter, a hydrate preservative, or any combination thereof.
21. The composition of embodiment 20 wherein the composition is sufficiently stable such that the composition is transportable at a temperature of −5° C. or higher and a pressure of 100 psig or lower and wherein a transported composition comprises at least about 40% of the hydrates in the composition prior to transport.
22. A system comprising:
a gas-to-hydrate reactor; and
a transportable storage module for storing hydrates formed in the gas-to-hydrate reactor.
23. The system of embodiment 22 wherein the system further comprises a module for dissociating hydrates formed in the gas-to-hydrate reactor.
24 The system of embodiment 22 wherein the system is portable.
25. The system of embodiment 23 wherein the system is portable.

What is claimed is:

1. A process for greenhouse gas abatement comprising:
reacting a greenhouse gas comprising methane, carbon dioxide, or a mixture thereof with water under conditions to form a mixture comprising hydrates;
transporting the formed mixture comprising hydrates to a location in need of gas wherein the transporting is conducted under conditions sufficient to preserve at least a portion of the hydrates in the formed mixture based on the total amount of hydrates formed in the reacting; and
converting the transported mixture comprising preserved hydrates to gas at or near the location in need of gas.

2. The process of claim 1 wherein the greenhouse gas is a flare gas.

3. The process of claim 2 wherein the flare gas further comprises hydrogen sulfide.

4. The process of claim 2 wherein the flare gas comprises at least about 5% carbon dioxide by mole of the flare gas based on the total molar amount of flare gas.

5. The process of claim 2 wherein the flare gas comprises at least about 50% methane by mole of the flare gas based on the total molar amount of flare gas.

6. The process of claim 2 wherein the flare gas comprises a mixture of methane and carbon dioxide and wherein the flare gas further comprises ethane, propane, butanes, pentanes, hexanes, nitrogen, or any mixture thereof.

7. The process of claim 2 wherein a rate of conversion of the flare gas-to-hydrates during the reacting is greater than a rate of conversion of pure methane to hydrates at the same reaction conditions.

8. The process of claim 1 wherein the greenhouse gas is captured from a sea floor and wherein the greenhouse gas further comprises hydrates prior to reacting.

9. The process of claim 1 which further comprises adding a promoter to the greenhouse gas prior to reacting, during reacting, or both.

10. The process of claim 9 wherein the promoter comprises a surfactant.

11. The process of claim 1 which further comprises adding a hydrate preservative.

12. The process of claim 11 wherein the hydrate preservative prevents or slows hydrate dissociation.

13. The process of claim 1 which further comprises adding a catalyst to the reacting step.

14. The process of claim 1 wherein at least a portion of the water comprises produced water from an oil or gas operation.

15. A composition comprising:
hydrates formed from a greenhouse gas; and
one or more of a catalyst, a promoter, a hydrate preservative, or any combination thereof.

16. A system comprising:
a gas-to-hydrate reactor; and
a transportable storage module for storing hydrates formed in the gas-to-hydrate reactor.

17. The system of claim 16 wherein the system further comprises a module for dissociating hydrates formed in the gas-to-hydrate reactor.

18. The system of claim 17 wherein the system is portable.

19. The system of claim 16 wherein the system is portable.
